(19) United States
(12) Patent Application Publication
(10) Pub. No.: US 2007/0143730 A1
(43) Pub. Date: Jun. 21, 2007

(54) Design method and system for generating behavioral description model

(75) Inventor: Shingo Kakui, Inagi-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: KABUSHIKI KAISHA TOSHIBA

(21) Appl. No.: 11/586,679

(22) Filed: Oct. 26, 2006

(30) Foreign Application Priority Data
Dec. 15, 2005 (JP) 2005-361958

(51) Int. Cl. G06F 17/50

(52) U.S. Cl. 716/18

(57) ABSTRACT

According to one embodiment, there is provided a design system for generating a behavioral description model used in a high-level synthesis system in circuit design. The design system includes an array expanding unit which expands an array for each element when the array is included in a process unit to be divided in a given behavioral description model, the array transferring information between the process unit and another process unit, and a model generating unit which generates a behavioral description model including descriptions of a plurality of process units generated by the array expanding unit.

### CROSS-REFERENCE TO RELATED APPLICATIONS

This application is based upon and claims the benefit of priority from Japanese Patent Application No. 2005-361958, filed Dec. 15, 2005, the entire contents of which are incorporated herein by reference.

### BACKGROUND

1. Field

One embodiment of the invention relates to a design system for generating a behavioral description model to be used in a high-level synthesis system in a circuit design and a design method for doing the same.

2. Description of the Related Art

A synthesis technique is often used in a circuit design for designing an integrated circuit or the like. According to this technique, a packaging (or mounting) model in which hardware circuitry is described in hardware description language (HDL) is automatically generated from a behavioral description model in which the operation algorithm of a circuit is described in the C-based language (C language or language having an expanded function of the C language). In particular, a technique capable of achieving synthesis from high-level descriptions having a high-degree of abstraction is called high-level synthesis, and some high-level synthesis techniques are commercially available as high-level synthesis tools.

For example, Jpn. Pat. Appln. KOKAI Publication No. 2004-54641 discloses that a module-to-module interface serving as an interface between a plurality of circuit modules that perform parallel operations is formed by high-level synthesis.

When a high-level synthesis tool processes high-level descriptions, the circuits to be generated vary in performance according to how to divide the descriptions (how to make each individual module or thread). A designer wishes to try to divide the descriptions in various ways. However, as long as the designer divides the descriptions by hand, the number of ways to divide them will be limited, with the result that a good circuit model cannot be generated.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary block diagram showing a configuration of the entire system including a high-level design system according to an embodiment of the invention;

FIG. 2 is an exemplary illustration of an array of functions in high-level descriptions;

FIG. 3 is an exemplary illustration of generation of descriptions that define signal lines and ports;

FIG. 4 is an exemplary illustration of a function having a child function;

FIG. 5 is an exemplary illustration of arbitration between modules that gain access to one memory; and

FIG. 6 is an exemplary flowchart illustrating an operation of the high-level design system.

### DETAILED DESCRIPTION

Various embodiments according to the invention will be described hereinafter with reference to the accompanying drawings. In general, according to one embodiment of the invention, there is provided a design system for generating a behavioral description model used in a high-level synthesis system in circuit design. The design system includes an array expanding unit which expands an array for each element when the array is included in a process unit to be divided in a given behavioral description model, the array transferring information between the process unit and another process unit, and a model generating unit which generates a behavioral description model including descriptions of a plurality of process units generated by the array expanding unit.

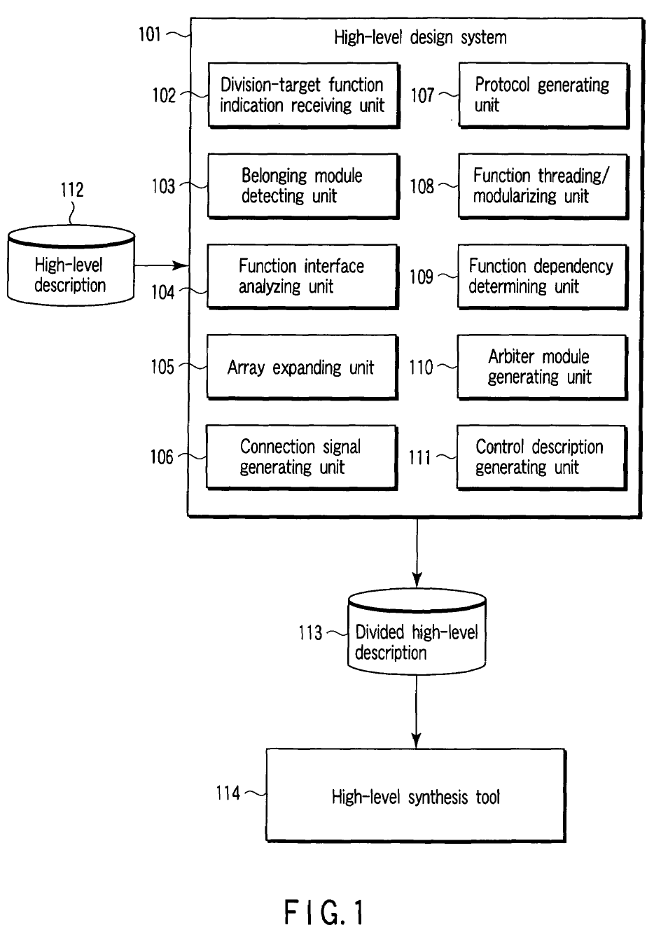

FIG. 1 is a block diagram showing a configuration of the entire system including a high-level design system according to the embodiment of the invention.

Referring to FIG. 1, the system includes a high-level design system 101, a first storage medium 112, a second storage medium 113 and a high-level synthesis tool 114.

The high-level design system 101 corresponds to an application program for automatically generating a behavioral description model that is suitable for processing in a high-level synthesis system (high-level synthesis tool 114). The high-level synthesis system performs a process of obtaining synthesis from high-level descriptions having a high-degree of abstraction. The high-level design system 101 is executed by a processor. Specifically, the system 101 reads the behavioral description model from the first storage medium 112, adjusts the model and writes the adjusted model to the second storage medium 113.

When a process unit to be divided in the behavioral description model obtained from the first storage medium 112 (in this embodiment, the process unit is defined as a function in a module) has an array for transferring a plurality of items of information to/from another process unit, the high-level design system 101 expands the array for each element (or it divides the function). The array means a collection of data items of the same type, which is to be processed, and has a plurality of elements. If there is an int-type (integer type) array declared as “int a[10];” in C language programming, the elements of the array are a[0], a[1], . . . , a[9]. The numbers in parentheses are called array subscript operators.

The first storage medium 112 stores a behavioral description model in which a designer previously describes the operation algorithm of a circuit in the C-based language (C language or language having an expanded function of the C language). In the behavioral description model, various modules (into which programs are divided by their independent functions) and threads (into which internal tasks are divided) are described. The behavioral description model can be used directly in the high-level synthesis tool 114. In the present embodiment, however, the behavioral description model is applied to the high-level design system 101 before it is used in the tool 114. The behavioral description model can include an indication description (e.g., comments and pragma descriptions of a specific format) for indicating a process unit to be divided.

The second storage medium 113 stores a high-level behavioral description model obtained after the dividing process of the high-level design system 101.

The high-level synthesis tool 114 corresponds to commercial application software for automatically generating a packaging model in which hardware circuitry is described in hardware description language, from a behavioral description model in which the operation algorithm of a circuit is described in the C-based language (C language or language having an expanded function of the C language). The high-level synthesis tool 114 is executed by the processor. In the present embodiment, the tool 114 performs high-level synthesis for the behavioral description model obtained after the dividing process and stored in the second storage medium 113.

The high-level design system 101 has various functions such as a division-target function indication receiving unit 102, a belonging module detecting unit 103, a function interface analyzing unit 104, an array expanding unit 105, a connection signal generating unit 106, a protocol generating unit 107, a function threading/modularizing unit 108, a function dependency determining unit 109, an arbiter module generating unit 110, and a control description generating unit 111.

The division-target function indication receiving unit 102 is a function of receiving a designer's indication of which portion of the high-level descriptions of the behavioral description model obtained from the first storage medium 112 is divided as another module or thread. If the above indication description is incorporated into the high-level descriptions, its lexical and syntactic analysis can be conducted to acquire the contents of the indication.

The belonging module detecting unit 103 is a function of detecting a module to which a division-target function indicated by the division-target function indication receiving unit 102 belongs. When the high-level description of the behavioral description model obtained from the first storage medium 112 is syntactically analyzed, an operator can read a module to which the indicated division-target function belongs, from a syntactic analysis tree.

The function interface analyzing unit 104 is a function of analyzing the argument (parameter) and return value of the division-target function indicated by the division-target function indication receiving unit 102. Since the interface such as the argument and the return value is implemented as a signal and a port after the dividing process, the unit 104 performs analyses on what bit information and how many items of the information are transferred, whether only the argument is used or a value is written to the argument and the argument is returned, whether the information is a scalar or an array, and the like. The information of the scalar or array is used to determine whether to execute the array expanding unit 105 (described later). The other information is used in the connection signal generating unit 106 (described later).

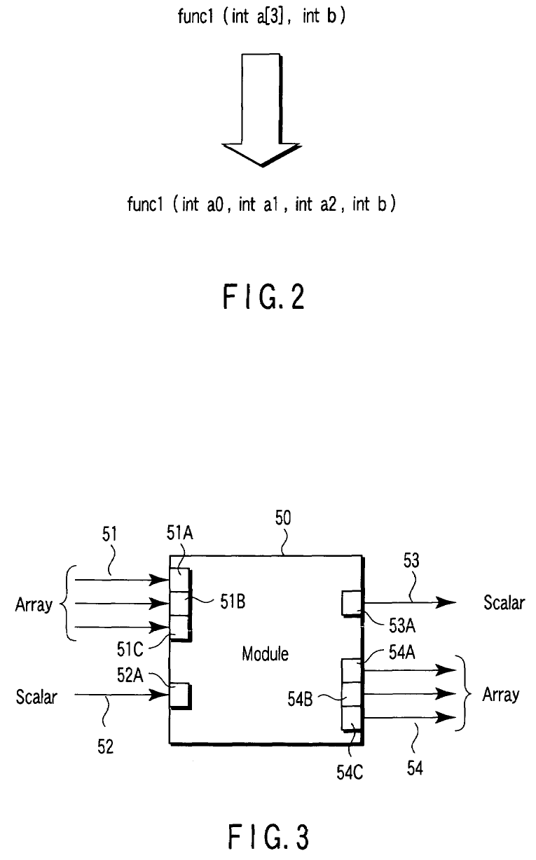

The array expanding unit 105 is a function that is performed when the interface of the function indicated by the division-target function indication receiving unit 102 includes an array. If an int-type array has ten elements, it is internally expanded to ten arguments of an int-type scalar or such information is generated in advance. Though the int-type array is treated as a scalar in terms of the C language, it has to be 32-bit vector signals when signals and ports are to be formed, because the int-type array cannot be implemented as an “array-type port” in which the array can be input to the commercial high-level synthesis tool 114 as it is. Each of the elements of the array have to be implemented as a signal and a port one by one. As shown in FIG. 2, when a division-target function func1 has an int-type array a[3], the array a[3] is expanded to three elements int a0, int a1, and int a2.

The connection signal generating unit 106 is a function of generating descriptions that define signal lines and ports for connecting individual modules and threads obtained by the dividing process, using the information analyzed so far. With the module division, descriptions of the signal lines and ports may be generated. With the thread division, only the descriptions of the signal lines may be generated and that of the ports need not be generated. When a module 50 as shown in FIG. 3 is divided, the unit 106 generates the descriptions that correspond to input signal lines 51 and ports 51A, 51B and 51C corresponding to the array, an input signal line 52 and a port 52A corresponding to the scalar, an output signal line 53 and a port 53A corresponding to the scalar, and output signal lines 54 and ports 54A, 54B and 54C corresponding to the array. In addition, the unit 106 generates the descriptions of control signals and ports such as a reset signal to return the system to its initial state, start/end signals and valid/invalid signals relating to the module obtained after the dividing process.

The protocol generating unit 107 is a function of generating a description that defines a communication protocol for performing a handshake between the individual modules and threads obtained by the dividing process. More specifically, the description may define that, e.g., the system stands by until it receives a start signal, a valid signal is enabled when the divided modules and threads complete their computations, the system returns to the head of a module or a thread upon a reset signal, and the like.

The function threading/modularizing unit 108 is a function of generating descriptions that define a module or a thread for wrapping the division-target functions indicated by the division-target function indication receiving unit 102, on the basis of information obtained so far.

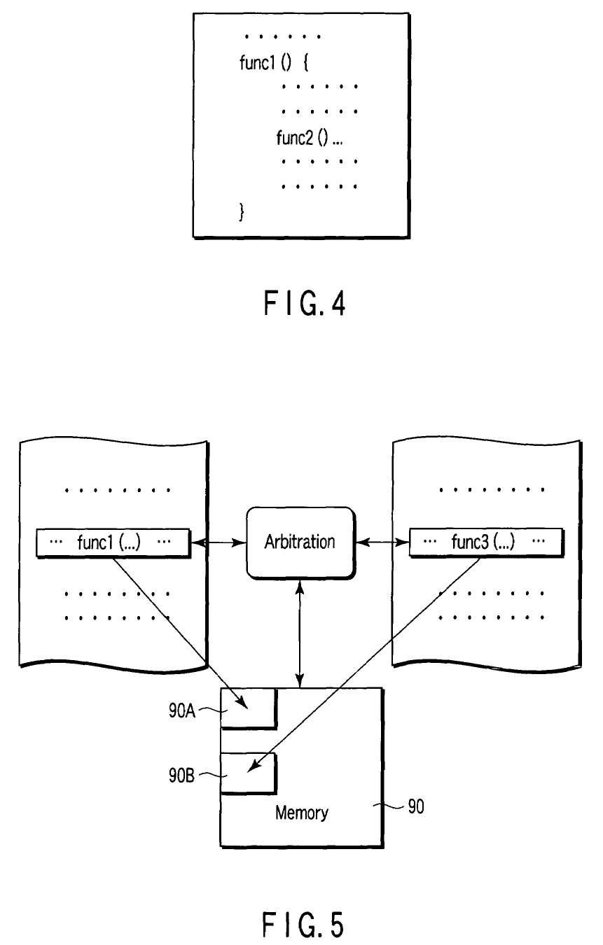

The function dependency determining unit 109 is a function of determining whether or not a division-target function includes a child function that depends on the function. The unit 109 is required when a division-target function indicated by the division-target function indication receiving unit 102 is to be copied to another module. If a division-target function func1 has a child function func2 as shown in FIG. 4, the child function may be copied to another module. The unit 109 can thus determine the dependency between functions and analyze a calling relationship between the functions. Copying of a function to another module can be performed by, e.g., the function threading/modularizing unit 108 described above.

The arbiter module generating unit 110 is a function of generating descriptions that define an arbiter module for avoiding a conflict between modules or threads obtained after a function is divided when the modules or threads gain access to one memory. Assume now that a module having a function func1 and a module having a function func3 gain access to a memory 90 at the same time, as shown in FIG. 5. In the example shown in FIG. 5, the module having a function func1 requests access to a storage area 90A on the memory 90, and the module having a function func3 requests access to the storage area 90B on the memory 90. However, a plurality of modules cannot gain access to the memory 90 simultaneously. If such an access conflict occurs, the arbiter module arbitrates between two modules that are to gain access to one memory simultaneously. In high-level descriptions, whether to use a memory after high-level synthesis may be determined according to whether access to data in an array is defined. With the C language, usually, it can be determined according to whether there is an array in arguments of a function. With the SystemC, in addition to this determination, whether there is an array-type variable in the members of a module class may be analyzed, and whether the variable is used by a division-target function may be analyzed. When a memory (array-type variable) is used, it is placed in the arbiter module, and high-level descriptions after the dividing process are configured to use an array of arbiter modules. The operations of the arbiter modules may be defined to adopt one of a plurality of modules or threads, which have gained access to the same array of arbiter modules. The specific way of controlling access depends upon the arbitration algorithm to be adopted.

The control description generating unit 111 is a function of generating descriptions that control timings to operate the divided modules and threads. More specifically, a calling portion of a division-target function may be replaced with the descriptions that a start signal for starting the divided modules and threads is enabled and a valid signal for a result is awaited.

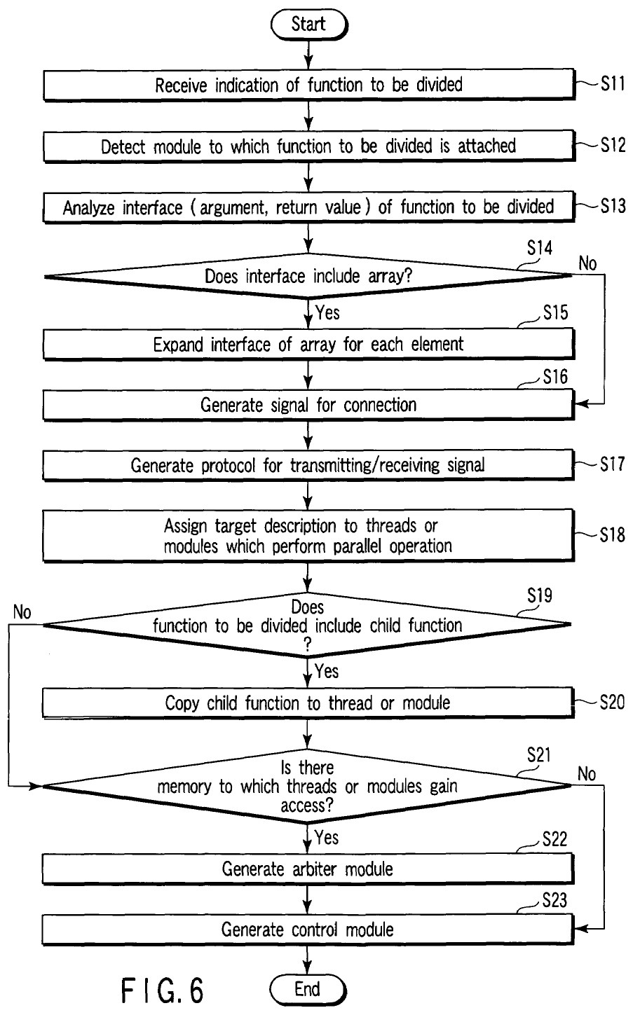

The operation of the high-level design system 101 will be described with reference to the block diagram shown in FIG. 1 and the flowchart shown in FIG. 6.

First, the division-target function indication receiving unit 102 receives an indication of a function to be divided by a designer (block S11). Thus, the belonging module detecting unit 103 detects a module to which the function belongs (block S12). The function interface analyzing unit 104 analyzes an interface (argument and return value) of the function (block S13) and determines whether or not the interface includes an array (block S14).

When the interface includes an array, the array expanding unit 105 performs a dividing process to expand the interface for each element (block S15). On the other hand, when the interface does not include any array, block S15 is skipped.

The connection signal generating unit 106 generates descriptions that define signal lines and ports for connecting the modules and threads obtained after the dividing process to an invoker (block S16). The protocol generating unit 107 generates a handshake protocol for receiving/transmitting signals (block S17) and at the same time it generates a start signal (port) and the like. The function threading/modularizing unit 108 assigns (the contents of) the function to be divided to another module or another thread (block S18).

The function dependency determining unit 109 determines whether or not the function to be divided includes a child function (block S19). If a child function is included, the function threading/modularizing unit 108 copies the child function to another module obtained after the dividing process (block S20). If it is not included, block S20 is skipped.

The function dependency determining unit 109 determines whether or not there is a memory (array-type variable) to which both the modules or threads obtained by the dividing process and their invoker gain access (block S21). If there is a memory, the arbiter module generating unit 110 generates an arbiter module to arbitrate between both accesses to the memory (block S22). If not, block S22 is skipped.

The control description generating unit 111 generates a module to control the start and stop of the modules and threads obtained by the dividing process (block S23).

When a behavioral description model including various modules that are formed through the dividing process is output from the high-level design system 101, it is stored in the storage medium 113 and then used in the high-level synthesis tool 114.

According to the embodiment of the invention described above, a designer can try to divide a process unit again and again by freely varying the high-level descriptions of a behavioral description model to be input to the high-level design system 101. Further, the high-level descriptions of a behavioral description model, which are suitable for processing in the high-level synthesis tool, are automatically generated from the high-level design system 101 by the number of times the designer has tried. Thus, the burden of the designer can greatly be decreased. Using the high-level design system 101, a designer can try a great variety of dividing methods and consequently the optimum circuit can be generated.

In the foregoing embodiment, the process unit to be divided is a function. The function can be replaced with a range of high-level descriptions. In this case, a component and a step for fulfilling a function of detecting a variable for transferring information between a designated range and its outside range and internally converting the variable into a function to detect an interface may be added.

The above-described procedures according to the embodiment of the invention are previously stored as computer programs in a computer-readable storage medium (e.g., a magnetic disk, an optical disk and a semiconductor memory) and, if necessary, they can be read and executed by a processor. The computer programs can be transferred and distributed from one computer to another one via a communication medium.

As has been described in detail, it is possible to effectively generate a behavioral description model that is suitable for processing in a high-level synthesis system.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A design system for generating a behavioral description model used in a high-level synthesis system in circuit design, the design system comprising:
an array expanding unit which expands an array for each element when the array is included in a process unit to be divided in a given behavioral description model, the array transferring information between the process unit and another process unit; and
a model generating unit which generates a behavioral description model including descriptions of a plurality of process units generated by the array expanding unit.

2. The design system according to claim 1, wherein the process unit is a function.

3. The design system according to claim 1, wherein the behavioral description model includes a description that indicates the process unit to be divided.

4. The design system according to claim 1, further comprising a connection signal generating unit which generates a description that defines signal lines to connect the process units generated by the array expanding unit,
wherein the model generating unit generates the behavioral description model including the description generated by the connection signal generating unit.

5. The design system according to claim 1, further comprising a protocol generating unit which generates a description that defines a communication protocol to perform a handshake between the process units generated by the array expanding unit,
wherein the model generating unit generates the behavioral description model further including the description generated by the protocol generating unit.

6. The design system according to claim 1, further comprising a modularizing unit which generates a description of at least one of a module and a thread including the process units generated by the array expanding unit,
wherein the model generating unit generates the behavioral description model further including the description generated by the modularizing unit.

7. The design system according to claim 1, further comprising a dependency determining unit which determines whether or not the process unit to be divided includes a child process unit which depends upon the process unit, and
wherein the modularizing unit copies the child process unit to another module when the dependency determining unit determines that the process unit to be divided includes the child process unit.

8. The design system according to claim 1, further comprising an arbiter module generating unit which generates a description that defines an arbiter module to avoid a conflict when a plurality of modules or threads, which are included in the behavioral description model generated after the array expanding unit expands the array, gain access to a single memory,
wherein the model generating unit generates the behavioral description model further including the description generated by the arbiter module generating unit.

9. The design system according to claim 1, further comprising a control description generating unit which generates a description to control timings to execute a plurality of modules or threads included in the behavioral description model after the array expanding unit expands the array,
wherein the model generating unit generates the behavioral description model further including the description generated by the control description generating unit.

10. A design method of generating behavioral description model used in a high-level synthesis system in circuit design, the method comprising:
expanding an array for each element when the array is included in a process unit to be divided in a given behavioral description model, the array transferring information between the process unit and another process unit; and
generating a behavioral description model including descriptions of a plurality of process units generated by the array expanding.
